(19) United States
(12) Patent Application Publication
(10) Pub. No.: US 2013/0097000 A1
(43) Pub. Date: Apr. 18, 2013

(54) METHOD AND SYSTEM FOR SELLING A PRODUCT ONLINE

(71) Applicants: Wen-Jung Hsueh, Tainan City (TW); Hsin Lee, Tainan City (TW)

(72) Inventors: Wen-Jung Hsueh, Tainan City (TW); Hsin Lee, Tainan City (TW)

(21) Appl. No.: 13/273,972

(22) Filed: Oct. 14, 2011

(51) Int. Cl. G06Q 30/02

(52) U.S. Cl. 705/14.23; 705/27.1

(57) ABSTRACT

A method of selling a product online over the Internet includes the steps of: providing a maze screen image having a plurality of user-configurable routes connecting first end points to second end points; receiving customer-identification information and route-configuration information, a portion of the user-configurable routes being configured according to the route-configuration information; associating one of a plurality of indicators with the customer-identification information, each of the indicators corresponding to one of the second end points; selecting one of the first end points when a predetermined termination condition is satisfied, and plotting on the maze screen image the user-configurable route from the selected one of the first end points to the corresponding one of the second end points; and conducting a transaction for the product with the customer having the customer-identification information that is associated with the indicator to which the user-configurable route plotted on the maze screen image corresponds.

### BACKGROUND OF THE INVENTION

1. Field of the Invention

The present invention relates to a method and a system for selling a product online, more particularly to a method and a system for selling a product online and for providing a benefit to selected customers.

2. Description of the Related Art

The trend of internet shopping activities has been growing rapidly in many countries. In most online shopping systems, product sellers would generally provide product information in a variety of forms, such as electronic catalogues, and may gain extra exposure by purchasing various advertisement packages offered by various multimedia platforms, such as portal websites and television channels. In addition, some product sellers may deliver advertisements via electronic mail.

However, such methods of exposing product information may be considered invasive and may be regarded as a form of burden especially by those who did not solicit for such information, which may render the advertisements ineffective and may even result in negative impressions of the products.

### SUMMARY OF THE INVENTION

Therefore, an object of the present invention is to provide a method of selling a product that is capable of alleviating the aforesaid drawbacks of the prior art.

According to the present invention, a method of selling a product online over the Internet is to be performed by a server device, and includes the steps of:

a) configuring the server device to provide a maze screen image having a plurality of first end points, a plurality of second end points, and a plurality of user-configurable routes connecting the first end points to the second end points;

b) configuring the server device to receive customer-identification information and route-configuration information from a customer who has decided to purchase the product;

c) configuring the server device to associate one of a plurality of indicators with the customer-identification information, each of the indicators corresponding to one of the second end points;

d) configuring the server device to select one of the first end points when a predetermined termination condition is satisfied, and to plot on the maze screen image the user-configurable route from the selected one of the first end points to the corresponding one of the second end points; and

e) for the customer having the customer-identification information that is associated with the indicator to which the user-configurable route plotted on the maze screen image corresponds, configuring the server device to conduct a transaction with the customer for the product.

In step b), a portion of the user-configurable routes is configured according to the route-configuration information. In step e), a benefit associated with purchase of the product is provided to the customer.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram to illustrate the preferred embodiment of a system for selling a product online over the Internet according to the present invention;

FIG. 2 is a flowchart to illustrate steps of the preferred embodiment of a method of selling a product online over the Internet according to the present invention;

FIG. 3 is an exemplary visual presentation of description information, indicators, and a maze screen image on a display unit according to the preferred embodiment; and

FIG. 4 is an exemplary visual presentation of description information, indicators, and a maze screen image on a display unit showing a selected one of the user-configurable routes according to the preferred embodiment.

### DETAILED DESCRIPTION OF THE PREFERRED EMBODIMENT

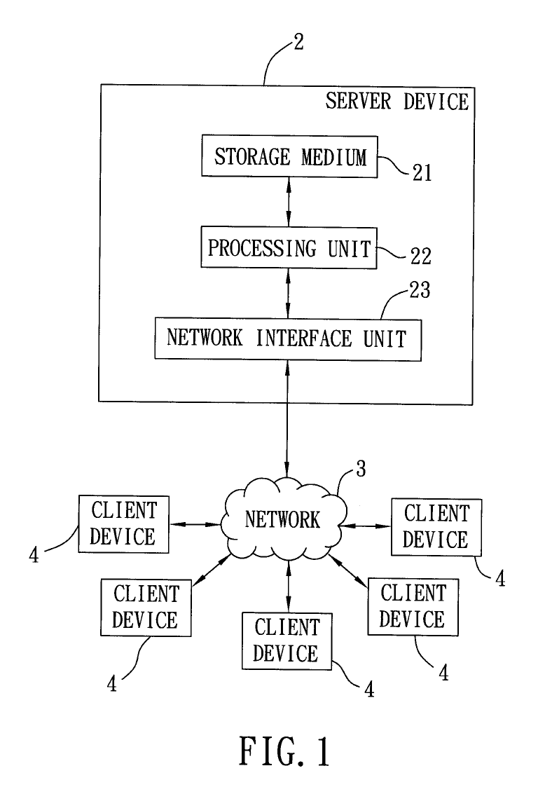

Referring to FIG. 1, the preferred embodiment of a system for selling a product online over the Internet includes a server device 2 including a storage medium 21, a processing unit 22 that is coupled electrically to the storage medium 21, and a network interface unit 23 that is coupled electrically to the processing unit 22. The processing unit 22 is configured to communicate with a plurality of client devices 4 (e.g., portable computers and mobile phones) through the network interface unit 23 via a network 3 (e.g., the Internet). It is to be noted that the term “product” as used herein can be a manufactured article or a service provided by a service provider.

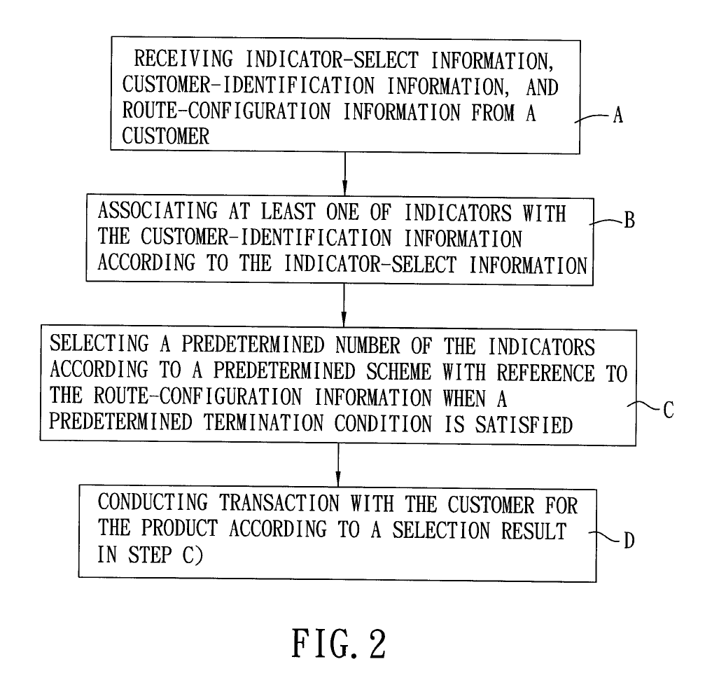

Referring to FIG. 2, the server device 2 is configured to perform steps of the preferred embodiment of a method of selling a product online over the Internet.

In an exemplary scenario, the storage medium 21 has a plurality of data entries stored therein, each of which corresponds to a product to be sold, and is associated with description information (e.g., a product-related image with accompanying descriptive text) and a predetermined set of indicators for customer association.

A customer who is interested in one of the products or has decided to purchase said one of the products may operate one of the client devices 4 to request the server device 2 for the description information and the indicators associated with one of the data entries that corresponds to said one of the products. In response to the user request, the server device 2 is configured to provide the description information and the indicators associated with said one of the data entries to the client device 4 of the customer.

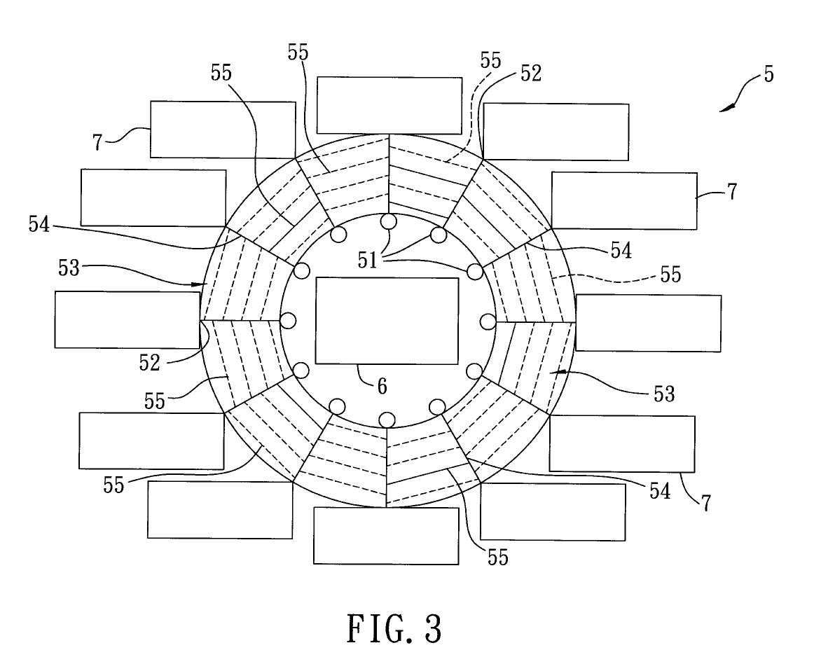

Upon receipt of the description information and the indicators, said one of the client devices 4, which preferably includes a display unit, is configured to present the description information and the indicators received thereby on the display unit. Shown in FIG. 3 is an exemplary visual presentation of the description information and the indicators on the display unit, where a maze screen image 5 is shown.

In this embodiment, the maze screen image 5 corresponds visually to a ring-shaped ladder-type maze having a plurality of first end points 51 (there are twelve first end points 51 in the embodiment) that form an inner ring, a plurality of second end points 52 (there are twelve second end points 52 in the embodiment) that form an outer ring, and a plurality of user-configurable routes 53 connecting the first endpoints 51 to the second end points 52. Further, the maze screen image 5 corresponds visually to a ladder-type maze having a plurality of stringers 54 (there are twelve stringers 54 in the embodiment) and a plurality of sets of rungs 55 (there are twelve sets, each having four rungs 55, in the embodiment). Each of the stringers 54 has a first end corresponding to a respective one of the first end points 51, and a second end corresponding to a respective one of the second end points 52. The stringers 54 extend in radial outward directions from the inner ring to the outer ring. Each of the sets of rungs 55 is disposed between a corresponding adjacent pair of the stringers 54. Each of the user-configurable routes 53 has segments corresponding to a part of the rungs 55.

The server device 2 is configured to display the description information received thereby in a box 6, and to display the indicators 7 such that the indicators 7 correspond to the second end points 52, respectively.

In the present embodiment, the first end points 51 are disposed such that the first end points 51 are equidistant to a geometric center of the box 6, and that each of first extending lines extending respectively from the first end points 51 to the geometric center of the box 6 forms a predetermined angle with an adjacent one of the first extending lines.

Preferably, for each adjacent pair of the stringers 54, the rungs 55 disposed therebetween are disposed parallel to one another, and are disposed such that a second extending line extending through respective center points of the rungs 55 extends through the geometric center of the box 6. However, visual presentation and configuration of the maze screen image 5 is not limited to such.

Moreover, although the indicators are not assigned with any numeral in this embodiment, they may be assigned with one of various numerals in other embodiments.

Next, the customer may further operate said one of the client devices 4 to register his/her interest in said one of the products. Specifically, the customer may operate said one of the client devices 4 to provide to the server device 2 indicator-select information that corresponds to said one of the data entries, customer-identification information that corresponds to the customer, and route-configuration information.

Upon receipt of the indicator-select information, the customer-identification information, and the route-configuration information, the server device 2 is configured for associating at least one of the indicators, that are associated with said one of the data entries, with the customer-identification information according to the indicator-select information, and for configuring a portion of the user-configurable routes 53 according to the route-configuration information.

In one modification, the server device 2 is configured to receive only the customer-identification information from the customer, and to associate at least a randomly selected one of the indicators, that are associated with said one of the data entries, with the customer-identification information received thereby.

In the exemplary scenario, indicators that have been registered with customer-identification information may not be registered again.

Preferably, a look-up table of the indicators and the customer-identification information associated therewith is stored in the storage medium 21 of the server device 2.

Each of the data entries is further associated with a predetermined termination condition. In this embodiment, the predetermined termination condition of said one of the data entries is satisfied when all of the indicators associated with said one of the data entries have been associated with customer-identification information. When the predetermined termination condition of said one of the data entries is satisfied, the server device 2 is configured to select a predetermined number of the indicators associated with said one of the data entries according to a predetermined scheme. It is to be noted that the predetermined termination condition may be otherwise in other embodiments. For example, the predetermined termination condition may be satisfied when a predetermined time is reached, and/or when a predetermined number of the indicators (i.e., not all of the indicators) have been respectively associated with customer-identification information.

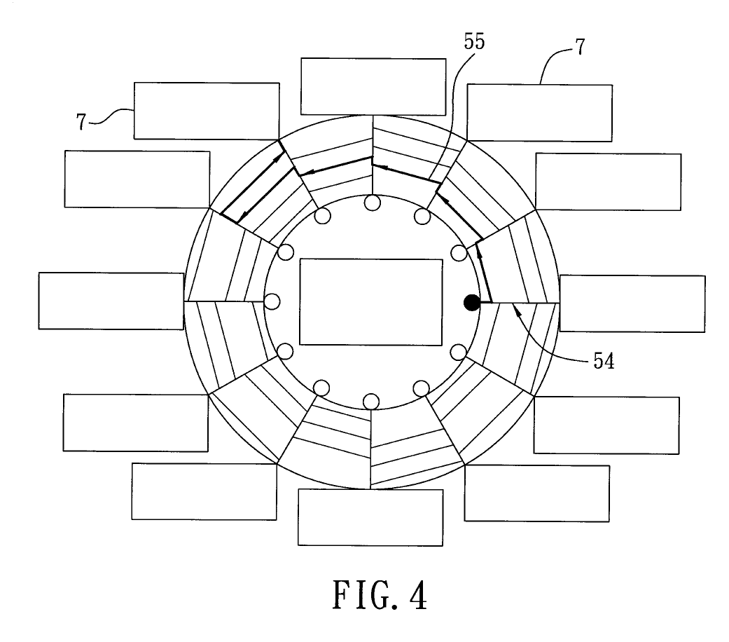

Referring to FIG. 4, in the present embodiment, the predetermined scheme includes switching each of the rungs 55 from a deactivated state (broken line state in FIG. 3) to an activated state (solid line state in FIG. 3) according to the route-configuration information, selecting one of the first end points 51 (such as through calculations involving looping algorithms), and subsequently plotting on the maze screen image 5 the user-configurable route from the selected one of the first end points 51 to the corresponding one of the second end points 52. It is to be noted that only the rungs 55 in the activated state and not the rungs 55 in the deactivated state can form segments of the user-configurable route plotted on the maze screen image 5.

When plotting the user-configurable route on the maze screen image 5, the route changes from one of the stringers 54 to one of the activated rungs 55 when an intersection between said one of the stringers 54 and said one of the activated rungs 55 is reached, and changes from one of the activated rungs 55 to one of the stringers 54 when an intersection between said one of the activated rungs 55 and said one of the stringers 54 is reached. Hence, the rungs 55 in adjacent sets should be staggered relative to each other to enable a user-configurable route to be successfully plotted from the selected first end points 51 to the corresponding second end points 52.

Next, for the customer having the customer-identification information that is associated with the indicator 7 to which the user-configurable route plotted on the maze screen image 5 corresponds, the server device 2 is configured to conduct a transaction with the customer for the product. A benefit, which may be a reduced price for purchase of the product, is provided to the customer.

It is worth noting that the predetermined scheme and the predetermined termination condition may be disclosed to potential customers upon request for the description information and the indicators, thereby eliminating customer concerns of cheating during selection of the indicators. Moreover, in other embodiments, the winning customer may be provided with other benefits, such as extra reward points and buy-one-get-one-free.

Preferably, customers deciding to purchase a product through the server device 2 have to pay a deposit, which is a fraction of the original product price, or deduct points from their accounts before being able to be associated with the identifiers.

Furthermore, in practice, the server device 2 is preferably configured not to disclose the state of each of the rungs 55 to the customers upon provision of the description information and the indicators thereto. The states of the rungs 55 are disclosed only when the predetermined termination condition is satisfied.

In summary, the preferred embodiment of a method of selling a product online over the Internet is capable of attracting customers' interests by providing benefits to selected customers through a selection scheme where customers provide the route-configuration information for configuring the routes connecting the first end points 51 to the second end points 52.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of selling a product online over the Internet, said method utilizing a server device and comprising the steps of:
configuring the server device to provide a maze screen image having a plurality of first end points, a plurality of second end points, and a plurality of user-configurable routes connecting the first end points to the second end points;
configuring the server device to receive customer-identification information and route-configuration information from a customer who has decided to purchase the product, wherein a portion of the user-configurable routes is configured according to the route-configuration information;
configuring the server device to associate one of a plurality of indicators with the customer-identification information, each of the indicators corresponding to one of the second end points;
configuring the server device to select one of the first end points when a predetermined termination condition is satisfied, and to plot on the maze screen image the user-configurable route from the selected one of the first end points to the corresponding one of the second end points; and
for the customer having the customer-identification information that is associated with the indicator to which the user-configurable route plotted on the maze screen image corresponds, configuring the server device to conduct a transaction with the customer for the product, wherein a benefit associated with purchase of the product is provided to the customer.

2. The method as claimed in claim 1, wherein the maze screen image corresponds visually to a ladder-type maze having
a plurality of stringers each having a first end corresponding to a respective one of the first end points, and a second end corresponding to a respective one of the second end points, and
a plurality of sets of rungs, each of the sets of rungs being disposed between a corresponding adjacent pair of the stringers; and wherein each of the user-configurable routes has segments corresponding to a part of the rungs.

3. The method as claimed in claim 2, wherein positions of the rungs between the corresponding adjacent pair of the stringers are configured according to the route-configuration information.

4. The method as claimed in claim 2, wherein each of the rungs is switched from a deactivated state to an activated state according to the route-configuration information, and only the rungs in the activated state and not the rungs in the deactivated state can form segments of the user-configurable route plotted.

5. The method as claimed in claim 2, wherein one of the plurality of first end points and the plurality of second end points form an inner ring, the other of the plurality of first end points and the plurality of second end points form an outer ring, and the stringers extend in radial outward directions from the inner ring to the outer ring.

6. The method as claimed in claim 1, wherein the server device is configured to receive indicator-select information from the customer, and the server device is configured to associate said one of the indicators with the customer-identification information according to the indicator-select information.

7. The method as claimed in claim 1, wherein the server device is configured to associate a randomly selected one of the indicators with the customer-identification information.

8. The method as claimed in claim 1, wherein the predetermined termination condition is satisfied when a predetermined number of the identifiers have been respectively associated with the corresponding customer-identification information.

9. The method as claimed in claim 1, wherein the benefit is a reduced price for purchase of the product.

10. The method as claimed in claim 1, wherein configuring the server device to associate one of a plurality of indicators with the customer-identification information includes storing a look-up table of the indicators and the customer-identification information associated therewith in a storage medium of the server device.

11. A system for selling a product online over the Internet, said system comprising a server device configured to:
provide a maze screen image having a plurality of first end points, a plurality of second end points, and a plurality of user-configurable routes connecting the first end points to the second end points;
receive customer-identification information and route-configuration information from a customer who has decided to purchase the product, wherein a portion of the user-configurable routes is configured according to the route-configuration information;
associate one of a plurality of indicators with the customer-identification information, each of the indicators corresponding to one of the second endpoints;
select one of the first end points when a predetermined termination condition is satisfied, and plot on the maze screen image the user-configurable route from the selected one of the first end points to the corresponding one of the second end points; and
for the customer having the customer-identification information that is associated with the indicator to which the user-configurable route plotted on the maze screen image corresponds, conduct a transaction with the customer for the product, wherein a benefit associated with purchase of the product is provided to the customer.

12. The system as claimed in claim 11, wherein the maze screen image corresponds visually to a ladder-type maze having
a plurality of stringers each having a first end corresponding to a respective one of the first end points, and a second end corresponding to a respective one of the second end points, and
a plurality of sets of rungs, each of the sets of rungs being disposed between a corresponding adjacent pair of the stringers; and
wherein each of the user-configurable routes has segments corresponding to a part of the rungs.

13. The system as claimed in claim 12, wherein positions of the rungs between the corresponding adjacent pair of the stringers are configured according to the route-configuration information.

14. The system as claimed in claim 12, wherein each of the rungs is switched from a deactivated state to an activated state according to the route-configuration information, and only the rungs in the activated state and not the rungs in the deactivated state can form segments of the user-configurable route plotted by the server device.

15. The system as claimed in claim 12, wherein one of the plurality of first end points and the plurality of second end point s form an inner ring, the other of the plurality of first end points and the plurality of second end points form an outer ring, and the stringers extend in radial outward directions from the inner ring to the outer ring.

16. The system as claimed in claim 11, wherein the server device is further configured to receive indicator-select information from the customer, and the server device is configured to associate said one of the indicators with the customer-identification information according to the indicator-select information.

17. The system as claimed in claim 11, wherein the server device is configured to associate a randomly selected one of the indicators with the customer-identification information.

18. The system as claimed in claim 11, wherein the predetermined termination condition is satisfied when a predetermined number of the identifiers have been respectively associated with the corresponding customer-identification information.

19. The system as claimed in claim 11, wherein the benefit is a reduced price for purchase of the product.

20. The system as claimed in claim 1, wherein the server device includes a storage medium for storing a look-up table of the indicators and the customer-identification information associated therewith.

21. A non-transitory machine-readable storage medium comprising program instructions which, when executed by a processor of a server device, configure the server device to perform consecutive steps of a method of selling a product online over the Internet according to claim 1.
